(19) United States
(12) Patent Application Publication
(10) Pub. No.: US 2013/0086579 A1
(43) Pub. Date: Apr. 4, 2013

(54) SYSTEM, METHOD, AND COMPUTER READABLE MEDIUM FOR IMPROVING VIRTUAL DESKTOP INFRASTRUCTURE PERFORMANCE

(71) Applicants: Jikku Venkat, Austin, TX (US); Leonardo Reiter, Austin, TX (US)

(72) Inventors: Jikku Venkat, Austin, TX (US); Leonardo Reiter, Austin, TX (US)

(73) Assignee: VIRTUAL BRIDGES, INC., Austin, TX (US)

(21) Appl. No.: 13/250,410

(22) Filed: Sep. 30, 2011

(51) Int. Cl. G06F 9/455

(52) U.S. Cl. 718/1

(57) ABSTRACT

The present disclosure provides a system, method, and computer readable medium for improved Virtual Desktop Infrastructure (VDI) performance by locally caching at least a part of a common operating environment (COE) gold image to hypervisor-node storage rather than shared data stores. Additionally, the present disclosure enables scheduled and differential synchronization of the gold images in off-hours to reduce loads on the shared data store.

### FIELD

This disclosure relates in general to the field of virtual desktop infrastructure.

### DESCRIPTION OF THE RELATED ART

Traditional virtual desktop infrastructure (VDI) implementations suffer from problems of performance, cost, and scalability stemming from architectural failures. A typical VDI deployment consists of a shared data store for storing user data and a common operating environment (COE) gold image. Virtual machines operating on hypervisor servers access the user data and COE gold image from the shared data store to provide a virtual desktop to remote clients. A hypervisor on a hypervisor server manages remote client and virtual machine interactions such as allocating memory for a virtual machine and providing a client access to a particular virtual machine.

Traditionally, hypervisors managed a number of virtual machines. The virtual machines transmitted and received both persistent user state data (e.g. user-saved documents; user-saved applications; etc.) and non-persistent system state data (such as may occur during boot-up or application launch phases of the computing process, among other processes) to and from shared data stores. Persistent user state data is usually marked by a need for reliability and other quality of service metrics, while non-persistent system state data demands more performance. Traditional shared data stores manage both persistent and non-persistent data to reduce complexity associated with migrating data to hypervisor servers.

However, network traffic associated with non-persistent system state data and reading the COE gold image put a strain on shared data stores, which are typically optimized for reliability. In order to handle persistent user state data, shared data stores operate on a costly type of storage known as “Tier 1” storage, which are marked for their reliability. The already costly “Tier 1 Storage” requires increased spindle capacity to handle the performance requirements of non-persistent system state data.

Thus, the constraints of performance and reliability associated with non-persistent and persistent data respectively have, in practice, made large scale VDI deployments too slow and/or costly for many enterprises.

### SUMMARY

Therefore, a need has arisen for a Virtual Desktop Infrastructure (VDI) architecture reducing performance strains on shared data stores.

The present disclosure enables locally caching at least a portion of a common operating environment (COE) gold image on hypervisor servers, enabling a reduction in network traffic to and from shared data stores. By locally caching at least a portion of a COE gold image, the present disclosure eliminates almost all non-persistent system state read/writes and COE gold image reads to shared data stores. Consequently, the present disclosure reduces the need for spindle capacity on shared data stores.

Further, the present disclosure provides methods, systems, and computer readable mediums for synchronization of authoritative COE gold images at a shared data store with locally cached COE gold images on hypervisor servers. Additional advantages of the present disclosure include scheduled and differential synchronization.

The methods, systems, and computer readable medium of the present disclosure allow about a 90% reduction in the spindle capacity of shared data stores while managing the complexity of locally cached COE gold images on the VDI network.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages included within this description, be within the scope of the accompanying claims.

### BRIEF DESCRIPTIONS OF THE DRAWINGS

The features, nature, and advantages of the disclosed subject matter may become more apparent from the detailed description set forth below when taken in conjunction with the drawings in which like reference numerals indicate like features and wherein:

FIG. 1 shows an exemplary computer system.

FIG. 2 shows an exemplary Virtual Desktop Infrastructure (VDI) architecture of the present disclosure;

FIG. 3 provides an exemplary high level overview of a common operating environment (COE) gold image;

FIG. 4 provides an exemplary low-level architectural view of a virtual machine;

FIG. 5 presents an exemplary user flow diagram; and

FIG. 6 shows an exemplary process flow for synchronizing an authoritative COE gold image.

### DETAILED DESCRIPTION OF THE ILLUSTRATIVE EMBODIMENTS

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like numbers being used to refer to like and corresponding parts of the various drawings.

The present disclosure provides methods, systems, and computer readable medium for improving Virtual Desktop Infrastructure (VDI) performance while reducing management complexity. The teachings of the present disclosure enable local caching of common operating environment (COE) gold images to and from local hypervisor servers enabling reduction in network traffic to shared data stores. These reductions in network traffic mitigate performance constraints on shared data stores to enhance efficiency, and allow reducing spindle capacity requirements of shared data stores by about 90%.

Additionally, by providing advanced methods for synchronization of COE gold images between hypervisor servers and authoritative COE gold images stored on shared data stores, the teachings of the present disclosure reduce complexity to enhance the viability of and produce further performance gains associated with local caching.

In one embodiment, the present disclosure enables scheduled synchronization of COE gold images amongst a cluster of hypervisor servers. In another embodiment, a differential synchronization process is provided.

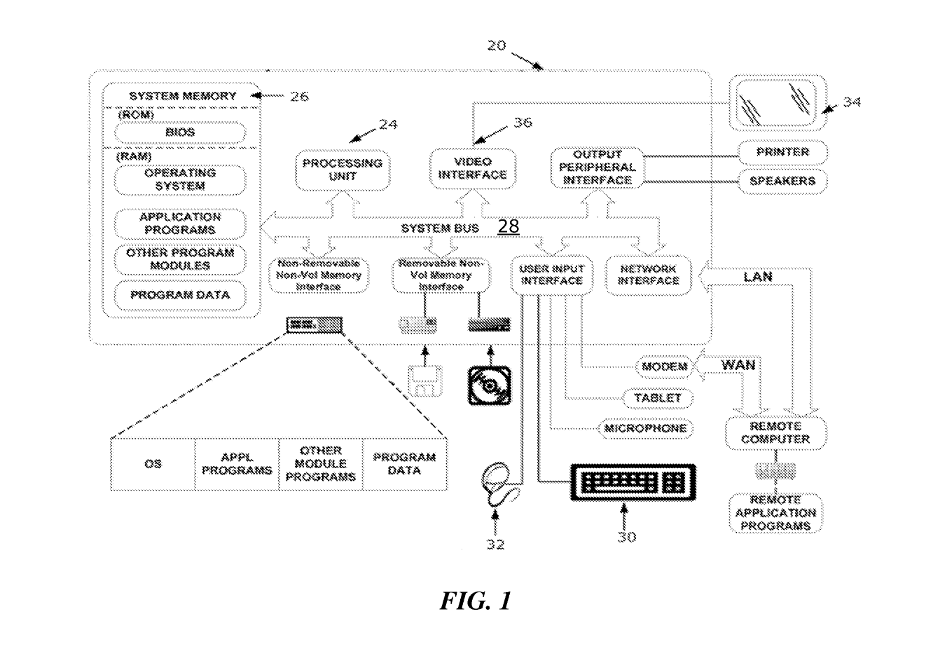

FIG. 1 shows an exemplary computer system, which includes a general purpose computing device in the form of a computing system 20, commercially available from Intel, IBM, AMD, and others. Components of the computing system may include, but are not limited to, a processing unit 24, a system memory 26, and a system bus 28 that couples various system components. Computing system 20 typically includes a variety of computer readable media, including both volatile and nonvolatile media, and removable and non-removable media. Computer memory may include, but is not limited to, RAM, ROM, EPROM, EEPROM, flash memory, or other memory technology, CD-ROM, DVD, or other optical disk storage, magnetic disks, or any other medium which can be used to store the desired information and which can be accessed by the computing system. A user may enter commands and information into the computing system through input devices such as keyboard 30, mouse 32, or other interfaces. Monitor 34 or other type of display device may also be connected to the system bus via interface 36. Monitor 34 may also be integrated with a touch-screen panel or the like. The computing system may operate in a networked environment using logical connections to one or more remote computers. The remote computing system may be a personal computer, a server, a router, a network PC, a peer device or other common network node, and typically includes many or all of the elements described above relative to the computing system.

A computing device such as the one shown in FIG. 1 may be used to implement various parts of the software of the present disclosure.

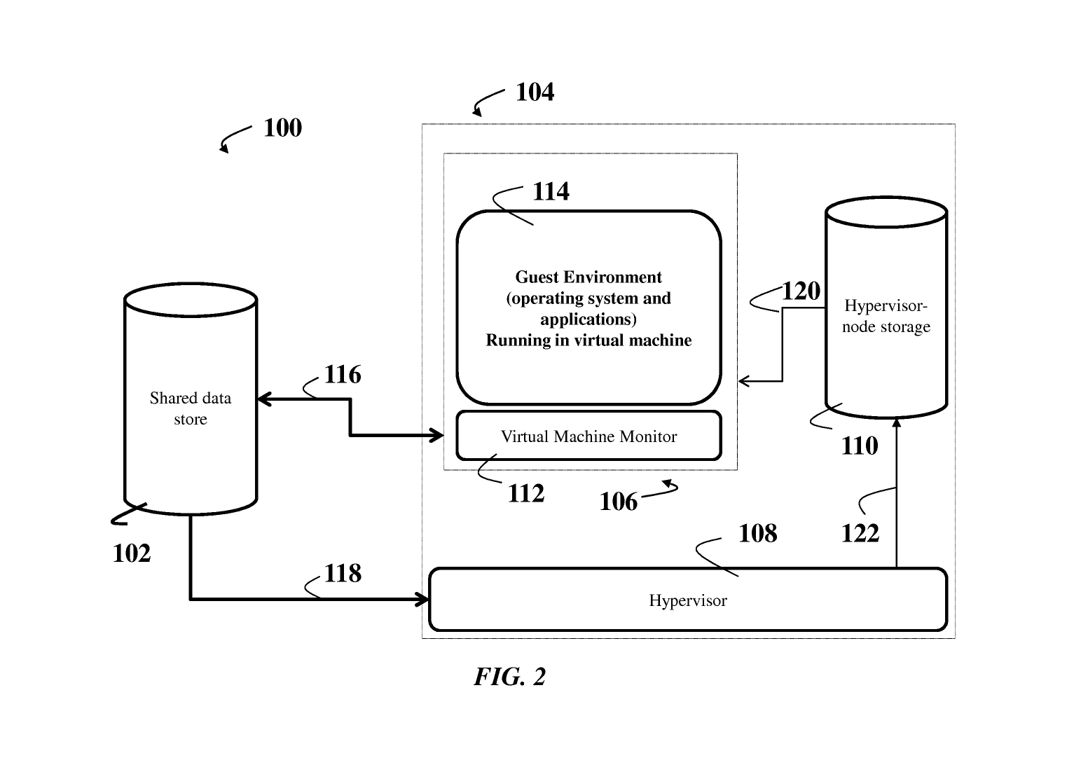

FIG. 2 provides an exemplary high-level view of VDI architecture 100 taught by the present disclosure. VDI architecture 100 provides shared data store 102 and hypervisor server 104. Hypervisor server 104 comprises virtual machine 106, hypervisor 108, and hypervisor-node storage 110. Those with ordinary skill in the art will note that many hypervisor servers 104 may communicate with shared data store 102. Further, hypervisor server 104 typically manages a number of virtual machines 106. VDI architecture 100 is intended to be a simplified depiction to teach the local caching system of the present disclosure. In other embodiments more hypervisor servers 104 may communicate with shared data stores 102, and each hypervisor server 104 may manage multiple virtual machines 106.

Shared data store 102 typically comprises a server or Redundant Array of Independent Disks (RAID) device. Shared data stores may also include Storage Area Network (SAN), Network Attached Storage (NAS), Direct Attached Storage (DAS), etc. Those with ordinary skill in the art will recognize advantages and disadvantages of the particular storage unit implemented in VDI architecture 100. Typically, network administrators choose shared data store 102 based on reliability, cost, storage, and performance guarantees.

The present disclosure provides shared data store 102 for storing persistent user state data including user-saved documents, settings, and even user saved applications and the like. For the purposes of the present disclosure, persistent user state data includes at least data which must be persisted back to a user for future virtual machine sessions. The reader will note some implementations of VDI architecture 100 may operate without the use of persistent user state data since there may be no need for data to be persisted back to the user. Shared data store 102 further comprises authoritative COE gold images.

Shared data store 102 communicates with hypervisor server 104, in particular hypervisor 108, to synchronize authoritative COE gold images on shared data store 102 with the locally cached COE gold images of hypervisor-node storage 110.

A single shared data store 102 may provision different types of COE gold image to hypervisor servers 104. For example, one type of COE gold image may provide a particular type of operating system (OS), package of applications, and/or package of desktop-settings. Each type of COE gold image may be updated with new applications, settings, or other features to create a new version of the authoritative COE gold image. Rather than creating an entirely new authoritative COE gold image, a network administrator is able to update an existing COE gold image to create a new version. Therefore, the present disclosure enables synchronization between the types and versions of authoritative COE gold images on shared data stores 102 and the respective COE gold image cached on hypervisor-node storage 110. The particular details of synchronization are addressed below.

Hypervisor server 104 reads authoritative COE gold image data through communications channel 118. Communications channel 118 may include a local area network (LAN) connection or Wide Area Network (WAN) connection among others.

Shared data store further communicates with hypervisor server 104, in particular virtual machine 106, to persist required persistent user state data back to virtual machine 106. In one embodiment, user and user state data exists in a 1:1 relationship. That is, a user may have individualized storage space, known as a user disk, exclusive to their user data, on shared data store 102. Other embodiments for provisioning persistent user state data back to a particular user are known to those with ordinary skill in the art. Shared data store communicates with virtual machine 106 through communications channel 116. Communications channel 116 may include a local area network (LAN) connection or Wide Area Network (WAN) connection among other network types.

Hypervisor server 104 comprises virtual machine 106, hypervisor 108, and hypervisor-node storage 110. Virtual machine 106 instantiates a COE gold image, at least in part, from locally cached version of the COE gold image located on hypervisor-node storage 110. In one embodiment, the entire COE gold image is cached on hypervisor-node storage 110. In other embodiments, COE gold images may be cached as dictated by enterprise requirements. Virtual machine 106 reads the portion of the COE gold image that is cached on the hypervisor-node storage 110 through communications channel 120 to instantiate the COE gold image. Whatever portion of the COE gold image that is not cached on the hypervisor-node storage 110, if any, is read from shared data store 102 via communications channel 116. Communications channel 120 may communicate using Internet Small Computer System Interface (iSCSI), Fiber Channel, or other known technologies. Virtual machine 106 further communicates with shared data store 102 to reads/write persistent user state data, providing a virtual desktop to a remote user.

Virtual machine 106 includes a guest operating environment 114 for providing a computing environment to a remote user and virtual machine monitor 112.

Hypervisor-node storage 110 locally caches COE gold image on local disk space in memory. Hypervisor-node storage 110 may include direct attached storage (DAS) or other local storage. In one embodiment, an elevator cache may be used to further locally cache those portions of COE gold image most often read by multiple virtual machines 106. In this way, hypervisor server 104 increases performance of virtual machines 106 reading common portions of a COE gold image by reading from hypervisor server 104 RAM instead of hypervisor-node storage 110.

It is important to clarify that all or only a portion of a COE gold image may be cached on hypervisor-node storage 110 and/or hypervisor server 104 to lessen strain on shared data store 102. By locally caching at least a portion of a COE gold image on hypervisor-node storage 110, read/write operations to shared data store may be reduced by as much as 90% since almost all read/write operations for non-persistent system state data and COE gold image reads are performed on hypervisor server 104, usually chosen for performance. For the purposes of this disclosure, non-persistent system state data includes at least some system state data which need not be persisted to future virtual computing sessions. Exemplary non-persistent system state data might include data which occur during the boot-up, log-in, application launch, or virus scan phases of the virtual computing process.

Hypervisor 108 communicates using communications channel 118 to synchronize authoritative COE gold images on shared data store 102 with locally cached COE gold images on hypervisor-node storage 110. Further, hypervisor 108 caches COE gold images on hypervisor-node storage 110 through communications channel 122. Communications channel 122 may communicate using iSCSI, Fiber Channel, or other known technologies. It is important to note that other embodiments may use other entities, besides hypervisor 108, to manage the synchronization of COE gold images. One of the important aspects highlighted here is that local caching of COE gold images on hypervisor server 104 may require synchronization to authoritative COE gold images from shared data store 102.

Hypervisor 108 further manages virtual machine 106 (and other virtual machines operating on hypervisor server 104). Hypervisor 108 typically performs such operations as allocating memory space for virtual machine 106 and connecting virtual machine 106 with a remote user.

The distributed nature of VDI architecture 100 allows shared data stores 102 to operate in separate locations from each hypervisor server 104. For example, in one embodiment, shared data store 102 and hypervisor server 104 may operate together in a centralized location (e.g. a data center) to provide virtual computing sessions to a remote user. In another embodiment, shared data store 102 may operate in a central location while hypervisor server 104 operates in another location (e.g. branch location). Further, the present disclosure enables multiple shared data stores 102 and hypervisor servers 104 to operate in combinations at multiple central locations and multiple branch locations as needed.

Further, VDI architecture 100 implementations which operate without the use of persistent state data may operate even when hypervisor server 104 loses connection to shared data store 102 since no user data need be stored on shared data store 102.

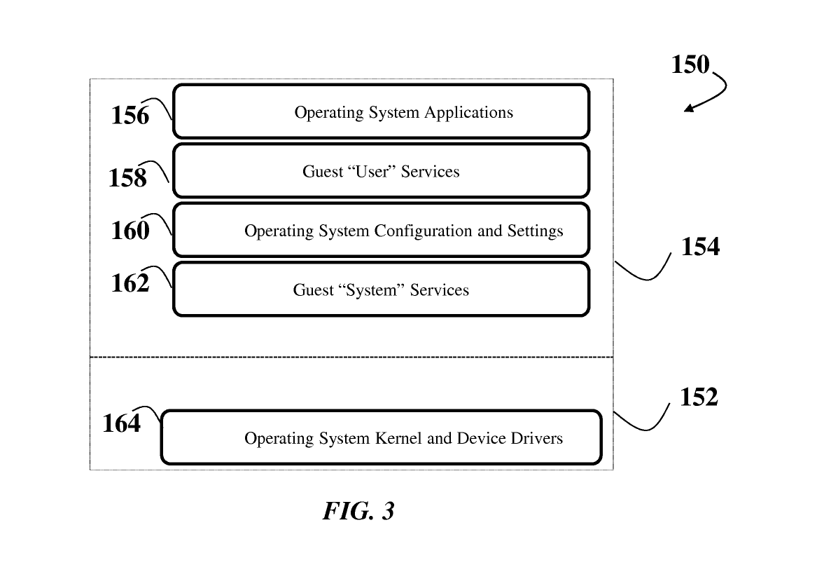

FIG. 3 provides a high level overview of COE gold image 150. COE gold image 150 enables network administrators to easily update an entire enterprise's software since VDI architecture 100 automatically provisions COE gold image 150 to the required hypervisor servers.

A COE gold image provides data for a master or “template” virtual machine installation that can then be deployed to multiple users for dynamic instantiation. Typically, a COE gold image includes a guest operating system (OS), applications, system-wide desktop configuration, and/or policies. COE gold image 150 provides one implementation of a COE gold image suitable for use with the methods, systems, and computer readable medium of the present disclosure. Those with ordinary skill in the art will recognize other suitable modifications and variations for operation with the teachings of the present disclosure.

COE gold image 150 provides kernel space 152 and user space 154. Kernel space 152 includes guest OS kernel and device drivers 164. Guest OS and device drivers 164 comprise programs and data intended to manage virtual machine resources. Guest OS kernel and device drivers provide the link between guest applications 156 and the actual hardware on a hypervisor server 104 performing the data processing. A network administrator may provision COE gold image 150 with the OS and device drivers necessary for their enterprise needs. Exemplary OS include Windows 7® (a trademark of Microsoft Corp.), Windows Vista® (trademark of Microsoft Corp.), Linux OS, or other OS. Network administrators may further provision the necessary device drivers needed to communicate with enterprise hardware.

User space 154 includes guest operating system applications 156, guest user services 158, guest operating system configurations and settings 160, and guest system services 162, Guest operating system applications 156 include applications such as word processing applications, web browsers, enterprise specific applications, accounting applications, and other applications. Guest operating system applications 156 help a user perform a specific task, whereas guest OS kernel and device drivers manage system resources.

Guest operating system and configuration settings 160 provide the authoritative system and configuration settings for the virtual machine 106. That is, each instance of a virtual machine 106, which instantiates COE gold image 150, starts with the specific configurations and settings defined by guest operating system and configuration settings 160. Typically, a user may change specific settings and configurations based on their security level, but these changes will not affect COE gold image 150.

A network administrator may provision the necessary COE applications, system-wide desktop configuration, and/or policies as needed by the enterprise. Typically, this configuration may not be changed by the user.

A network administrator may update COE gold image 150 or create a new COE gold image to provision hypervisor servers 104 of FIG. 2. As was stated earlier, the present disclosure enables synchronization of authoritative COE gold images stored on shared data store 102 with locally cached COE gold image on hypervisor-node storage 110. Typically, users may not modify COE gold image 150, but only modify their specific user state data such as user created documents, user applied settings, and even some user specific applications. The specific user state data is layered on top of each instance of COE gold image 150. Further, in one embodiment, user state data contained in a disk is 1:1 between a user and user disk. Shared data store 102 stores persistent user state data required for the user disk.

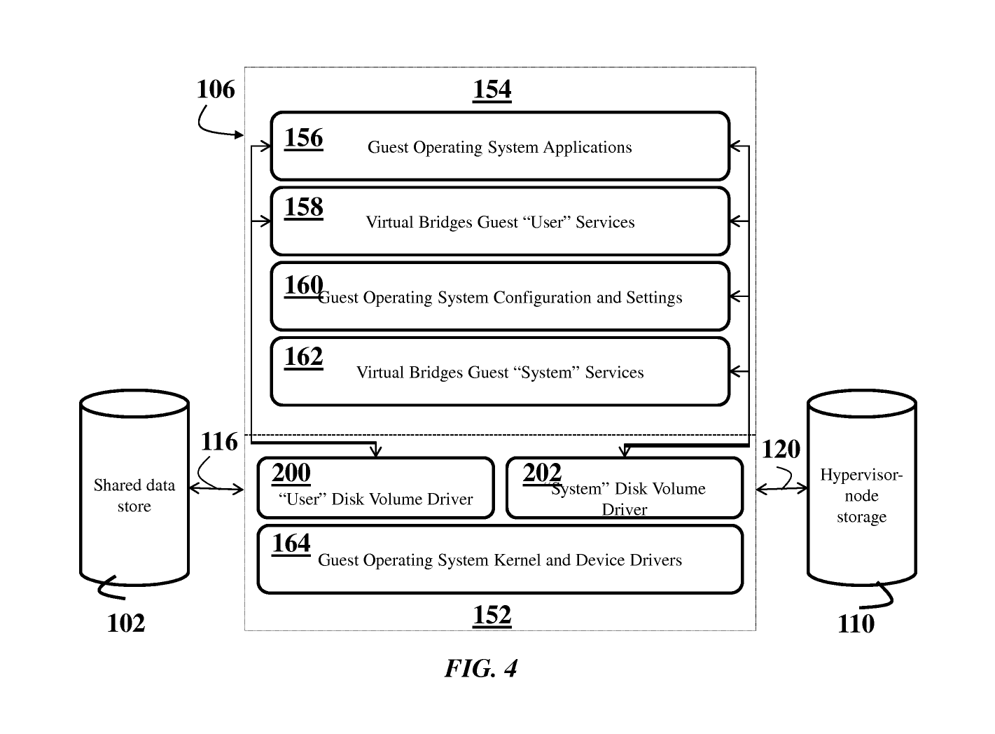

FIG. 4 provides a low-level architectural view of virtual machine 106 in communication with shared data store 102 and hypervisor-node storage 110. Virtual machine 106 communicates with shared data store 102 through communications path 116. Virtual machine 106 communicates with hypervisor-node storage 110 through communications path 120.

Virtual machine 106 instantiates COE gold image 150 from hypervisor-node storage 110. Thus, COE gold image 150 allows virtual machine 106 to be automatically provisioned with guest operating system applications 156, guest “user” services 158, guest operating system configuration and settings 160, and guest “system” services 162. Further, guest operating system kernel and device drivers 164 provide the link between the applications and the processing done at the hardware level. Virtual machine 106 further includes “user” disk volume driver 200 and “system” disk volume driver 202.

As previously stated, COE gold image 150 provides an exemplary gold image which may be used in combination with the local caching taught by the present disclosure. Thus, virtual machine 106 is only one of many virtual machine architectures which may be used in combination with the teachings of the present disclosure.

“User” disk volume driver 200 communicates with guest operating system applications 156 and “user” services 158 to cache persistent user state data. Thus, “user” disk volume driver 200 includes a virtual machine cache for reading/writing persistent user state data to shared data store 102. Inside the computing environment of virtual machine 106, user state data such as user saved documents, settings, and even user saved applications are directed to a drive (for example, the D: drive) of virtual machine 106.

As stated earlier, for the purposes of the present disclosure, persistent user state data includes at least data which must be persisted back to a user for future virtual computing sessions. The reader will note some implementations of VDI architecture 100 may operate without the use of persistent user state data since there may be no need for data to be persisted back to the user. Persistent user state data may include user documents, user settings, and even user saved applications among other data. Those with ordinary skill in the art will recognize other data which may need to be persisted back to a user upon a future virtual machine session. Such data may vary from enterprise to enterprise.

Typically, the need for reliability necessitates migration of persistent user state data to shared data store 102. Migrating persistent user state data need not be a concern, since during steady-state operation persistent user state data read/write operations are minimal. In fact, persistent user state data may necessitate as little as 5 input output operations per second (IOPS) on shared data store 102, thereby mitigating performance concerns and reducing spindle capacity requirements on shared data store 102. Typically, virtual machine cache communicates using asynchronous I/O, enabling user space 154 and kernel space 152 to continue other operations. An elevator cache may further enable improvements to virtual machine cache of “user” disk volume driver 200.

“System” disk volume driver 202 communicates with guest OS applications 156, guest “user” services 158, guest OS configuration and settings 160, and guest “system” services 162 to read/write non-persistent system state data, such as non-persistent runtime state data. “System” disk volume driver 202 reads/writes non-persistent system state data to and from copy-on-write bit buckets in hypervisor-node storage 110. Those with ordinary skill in the art will recognize a typical OS may not be able to operate on a read-only disk. However, a COE gold image stored on hypervisor-node storage 110 is read only to prevent a user from changing the COE gold image. To solve this problem at the virtual machine level, “System” disk volume driver 202 temporarily stores any non-persistent system state data changes required by an OS onto copy-on-write bit buckets stored in hypervisor-node storage 110. Thus, the OS may operate on virtual machine 106 and the COE gold image on hypervisor-node storage 110 may still operate in a read-only mode. These copy-on-write bit buckets do not need to be accessed by virtual machine 106 after terminating a virtual computing session, however. In this manner, “system” disk volume driver 202 further performs read/write operations for non-persistent system state data in association with copy-on-write bit buckets of hypervisor-node storage 110.

As noted earlier, for the purposes of this disclosure, non-persistent system state data includes at least some system state data which need not be persisted to future virtual machine computing sessions. Exemplary non-persistent system state data might include data which occur during the boot-up, log-in, application launch, or virus scan phases of the virtual computing process.

By storing non-persistent system state data within hypervisor-node storage 110 rather than transmitting the non-persistent system state data back to shared data store 102, the present disclosure mitigates performance concerns associated with shared data store 102. In fact, spindle capacity of shared data store 102 may be reduced by as much as 90%. Typically, a single user may generate about 50 IOPS during boot-up, anti-virus scans, logins, and application launches. Thus large numbers of users performing these actions at once result in large load on the network, and large spindle capacity requirements of shared data store 102. “System” disk volume driver 202 offloads these IOPS onto hypervisor-node storage 110.

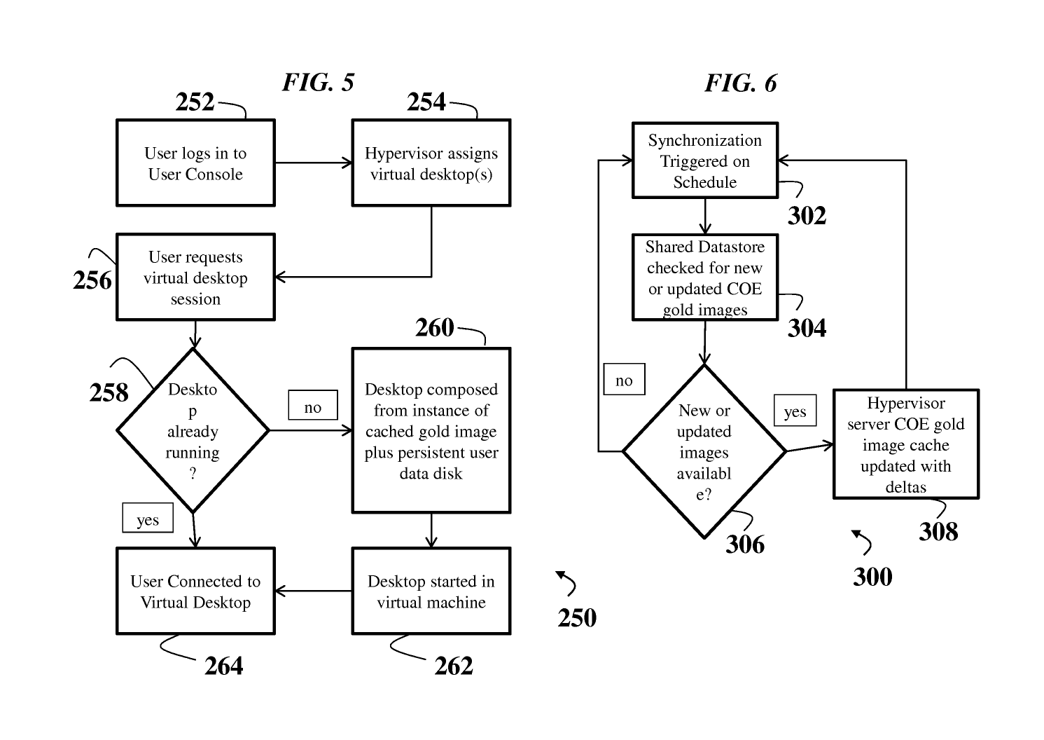

FIG. 5 provides an exemplary user flow diagram 250. In step 252, a user logs into a user console from their device (e.g. a general purpose computing device, thin-client, tablet, laptop, slate, mobile device, smart-phone, etc. which may require a virtual computing session.

In step 254, hypervisor 108 assigns a virtual desktop, hosted on hypervisor server 104, to the device.

In step 256, the user requests a virtual desktop session. A user may require a virtual desktop session to receive access to documents, applications, OS, or other features provided by virtual machine 106 which are not available on their own device.

In decision branch 258, hypervisor 108 processes the user request by first determining whether hypervisor server 104 is hosting a virtual machine 106 having the COE gold image requirements necessitated by the user's credentials. If the answer is no user process flow 250 proceeds to step 260, otherwise user process flow 250 proceeds to step 264.

If the answer to decision branch 258 is no, hypervisor 108 composes a virtual desktop from a cached COE gold image on hypervisor server 104 and the persistent user data disk located on shared data store 102 in step 260.

In step 262, the virtual desktop is started in virtual machine 106. During this step, the operating system of virtual machine 106 boots-up requiring large non-persistent system state IOPS. During this boot up phase, on average, nearly all, if not all, of the IOPS occur for non-persistent system state data, and in about 90/10 read/write mix. By locally caching COE gold image on hypervisor server 110, the VDI architecture of the present disclosure offloads these IOPS from shared data store 102 to hypervisor-node storage 110.

In step 264, a user is connected to the virtual desktop composed of virtual machine 106 and user persistent data disk hosted on shared data store 102. A user may log in to their virtual desktop, starting their virtual computing session. During the virtual computing session, users may launch applications, typically this phase of the virtual computing sessions splits IOPS between system state and user state about 90/10, with about a 50/50 read/write mix occurring for system state operations.

Steady-state operation during the computing session divides system state and user state operations about 50/50, with about a 20/80 read/write mix occurring for both system state and user state operations.

When a user logs out of the virtual desktop, the virtual computing session terminates and non-persistent system state data may be discarded and hypervisor 108 may allocate the memory space as needed.

FIG. 6 presents synchronization process flow 300 for synchronizing authoritative COE gold images with locally cached gold images on hypervisor-node storage 110. As previously explained, shared data store 102 stores authoritative COE gold images which are, at least in part, locally cached on hypervisor-node storage to offload non-persistent system state IOPS and COE gold image reads onto hypervisor-node storage 110. In one embodiment, a network administrator may wish to update authoritative COE gold images with a new application, setting, or other features. In another embodiment, a network administrator may simply wish to create a new COE gold image. Using synchronization process flow 300 of the present disclosure, the network administrator need only update or create new COE gold images and the needed authoritative COE gold image located at shared data store 102 will be synchronized with the locally cached COE gold images on hypervisor-node storage 110.

Synchronization process flow 300 enables scheduled synchronization, reducing IOPS from shared data stores during peak hours, as would be the case for on-demand synchronization.

In step 302, synchronization process flow 300 is automatically triggered. A network administrator chooses scheduled times to trigger synchronization process flow 300. In one embodiment, a network administrator may schedule synchronization process for a particular hypervisor server. In another embodiment, a cluster of hypervisor servers may be chosen. Further, a network administrator may schedule process flow 300 for low-activity hours when shared data store 102 experiences less network traffic. Using off-hours synchronization ensures the caching process does not strain shared data store 102 with IOPS during peak-hours when shared data store 102 may be burdened with persistent user state IOPS.

In step 304, hypervisor servers 104 automatically check shared data store 102 for new or updated COE gold images. In one embodiment, metadata associated with each authoritative COE gold image keeps track of the version and type of the COE gold image along with associated changes to the COE gold image. Other methods may also be used to ensure the correct version and type of COE gold images are synchronized with hypervisor servers 104.

If the authoritative COE gold image has been updated, hypervisor 108 caches the authoritative COE gold image on hypervisor-node storage 110 in step 308. In one embodiment, only those portions of COE gold image which have been updated may be updated in the cache. This differential synchronization reduces strains on VDI networks. In another embodiment, the entire COE gold image may be re-cached.

If the authoritative COE gold image has not been updated, the synchronization process returns to step 302 to await the next scheduled synchronization.

In one embodiment, virtual machines 106 continue to operate using a previously stored COE gold image while the synchronization process occurs. Thus, reducing service interruption to clients. After the authoritative COE gold image from shared data store 102 has been locally cached, at least in part, on hypervisor-node storage 110, data may be cleaned and virtual machines 106 may operate using the new version or type of authoritative COE gold image which has been locally cached.

In summary, the present disclosure provides a system, method, and computer readable medium for improved Virtual Desktop Infrastructure (VDI) performance by locally caching at least a part of a common operating environment (COE) gold image to hypervisor-node storage rather than shared data stores. Additionally, the present disclosure enables scheduled and differential synchronization of the gold images in off-hours to reduce loads on the shared data store.

The foregoing description of the preferred embodiments is provided to enable a person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A system for improved virtual desktop infrastructure performance employing local caching, the system comprising:
at least one hypervisor server capable of providing at least one virtual machine to at least one device, said at least one hypervisor server comprising:
at least one common operating environment gold image, wherein at least a portion of said at least one common operating environment gold image resides on a hypervisor-node storage of said at least one hypervisor server;
said at least one virtual machine instantiating said at least one common operating environment gold image, said at least one virtual machine comprising:
a virtual machine cache, said virtual machine cache storing persistent user state data; and
a copy-on-write bit bucket, said copy-on-write bit bucket temporarily storing non-persistent system state data;
wherein said virtual machine cache is capable of transmitting and receiving said persistent user state data to and from at least one shared data store; and
said at least one shared data store storing at least one authoritative common operating environment gold image, wherein said at least one authoritative common operating environment gold image is synchronized with said at least one common operating environment gold image residing on said at least one hypervisor-node storage.

2. The system of claim 1, wherein said at least one shared data store is in a central location and said at least one hypervisor server is in branch location.

3. The system of claim 1, wherein said at least one shared data store and said at least one hypervisor server are located in a central location.

4. The system of claim 1, wherein said at least one authoritative common operating environment gold image and said portion of at least one common operating environment gold image residing on said hypervisor-node storage are synchronized on a predetermined schedule.

5. The system of claim 1, wherein said at least one authoritative common operating environment gold image and said portion of at least one common operating environment gold image residing on said hypervisor-node storage are differentially synchronized.

6. The system of claim 1, wherein said hypervisor-node storage comprises direct attached storage.

7. The system of claim 1, wherein said hypervisor-node storage comprises local storage.

8. The system of claim 1, wherein approximately 90% of system state input/output operations occur on said at least one hypervisor server.

9. A method for improving virtual desktop infrastructure performance employing local caching, the system comprising:
caching at least a portion of a common operating environment gold image on a hypervisor-node storage, said hypervisor-node storage residing on a hypervisor server;
reading at least a portion of said common operating environment gold image from said hypervisor-node storage to instantiate said common operating environment gold image on at least one virtual machine, said at least one virtual machine residing on said hypervisor server;
writing non-persistent system state data to a copy-on-write bit bucket, said copy-on-write bit bucket temporarily storing said non-persistent system state data, said copy-on-write bit bucket residing on said at least one virtual machine;
writing persistent user state data to a virtual machine cache, said virtual machine cache residing on said at least one virtual machine, said virtual machine cache capable of transmitting and receiving said persistent user state data to and from at least one shared data store; and
synchronizing said common operating environment gold image with an authoritative common operating environment gold image residing on said at least one shared data store.

10. The method of claim 9, wherein said step of synchronizing further comprises the step of synchronizing on a predetermined schedule.

11. The method of claim 10, wherein said step of synchronizing further comprises the step of scheduling synchronization during off-hours.

12. The method of claim 9, wherein said step of synchronizing further comprises the step of differential synchronization.

13. The method of claim 10, wherein said step of caching at least a portion of said common operating environment gold image further comprises the step of caching said common operating environment gold image entirely on said hypervisor-node storage.

14. The method of claim 13, wherein said step of reading at least a portion of said common operating environment continues when said hypervisor server is disconnected from said at least one shared data store.

15. The method of claim 13, wherein said step of reading at least a portion of said portion of said common operating environment gold image from said hypervisor-node storage further comprises the step of reading said common operating environment gold image entirely from said hypervisor-node storage.

16. A system for improved virtual desktop infrastructure performance employing local caching, the system comprising:
at least one hypervisor server capable of providing at least one virtual machine to at least one device, said at least one hypervisor server comprising:
at least one common operating environment gold image, wherein at least a portion of said at least one common operating environment gold image resides on a hypervisor-node storage of said at least one hypervisor server;
said at least one virtual machine instantiating said at least one common operating environment gold image, said at least one virtual machine comprising a copy-on-write bit bucket temporarily storing non-persistent system state data; and
said at least one shared data store storing at least one authoritative common operating environment gold image, wherein said at least one authoritative common operating environment gold image is synchronized with said at least one common operating environment gold image residing on said at least one hypervisor-node storage.

17. The system of claim 16, wherein said at least one shared data store is in a central location and said at least one hypervisor server is in branch location.

18. The system of claim 16, wherein said at least one shared data store and said at least one hypervisor server are located in a central location.

19. The system of claim 16, wherein said at least one authoritative common operating environment gold image and said portion of at least one common operating environment gold image residing on said hypervisor-node storage are synchronized on a predetermined schedule.

20. The system of claim 16, wherein said at least one authoritative common operating environment gold image and said portion of at least one common operating environment gold image residing on said hypervisor-node storage are differentially synchronized.
